(19) United States
(12) Patent Application Publication
(10) Pub. No.: US 2008/0238285 A1
(43) Pub. Date: Oct. 2, 2008

(54) Carbon nanotube field emitter and method for fabricating the same

(76) Inventors: Soon-Hyung Hong, Yuseong-ku (KR); Chan-Bin Mo, Yuseong-ku (KR)

Correspondence Address: THE NATH LAW GROUP, 112 South West Street, Alexandria, VA, 22314, US

(21) Appl. No.: 11/902,950

(22) Filed: Sep. 26, 2007

(30) Foreign Application Priority Data
Dec. 26, 2006 (KR) 10-2006-0133799

(51) Int. Cl. H01J 1/02; H01J 9/02

(52) U.S. Cl. 313/309; 445/24; 977/842

(57) ABSTRACT

The present invention relates to a long-life carbon nanotube field emitter with a three-dimensional structure and method for fabricating the same. Since the emitter having an extended area according to the design of the present invention can minimize the current density flowing per single wire of the carbon nanotube, it can be expected that the damage of the carbon nanotube is minimized so that the lifetime of the field emitter can be significantly improved and the commercialization of the carbon nanotube field emitter will be advanced.

This application claims priority to Korean Patent Application No. 2006-0133799, filed on Dec. 26, 2006, in the Korean Intellectual Property Office, the entire contents of which are hereby incorporated by reference.

### BACKGROUND OF THE INVENTION

1. Field of the Invention

The present invention relates to a carbon nanotube field emitter and a method for fabricating the same, and in particular to a long-life carbon nanotube field emitter with a three-dimensional structure and a method for fabricating the same.

2. Description of the Related Art

A carbon nanotube has large aspect ratio, high electrical conductivity, and physicochemical stability so that it is very ideal as a material of the field emitter. It has been known that the field emitter using the carbon nanotube has higher efficiency than that of the field emitter using existing metal and silicon. Therefore, much research has been attempted to fabricate the field emitter using the carbon nanotube, wherein the field emitter has been fabricated in a type such as a diode type (see FIG. 1), a triode type (see FIGS. 2 to 4), etc., using a chemical vapor deposition method or a screen printing process, and the like.

FIG. 1 is a cross-sectional view for explaining the concept of a diode type carbon nanotube field emitter of the prior art. There is also shown an electrical connection in order to explain the operation of the carbon nanotube field emitter. The same reference numerals indicate the same components throughout the following drawings and a duplicated description thereof will be omitted. It can be appreciated from FIG. 1 that the carbon nanotube 30 is formed from a cathode electrode 10 on a substrate 5. An anode electrode 20 and a phosphor 21 are disposed to be opposite each other at a position spaced by a predetermined distance above the carbon nanotube 30. Voltage is applied between the cathode electrode 10 and the anode electrode 20 to operate the carbon nanotube field emitter. In such a diode type carbon nanotube field emitter, since the carbon nanotube 30 is formed on the cathode electrode 10 that is a two-dimensional plane, it has a problem that it is difficult to increase the number of carbon nanotubes per unit area.

FIG. 2 is a cross-sectional view for explaining the concept of a triode type carbon nanotube field emitter of the prior art using a metal grid gate. The difference between FIG. 1 and FIG. 2 is that the triode carbon nanotube field emitter of FIG. 2 is further provided with the metal grid gate 40. Even in this case, the triode carbon nanotube field emitter also has a problem that it is difficult to increase the number of carbon nanotubes per unit area.

FIG. 3 is a cross-sectional view for explaining the concept of the triode type carbon nanotube field emitter of the prior art, wherein the metal gate is positioned at a side of a substrate. It can be appreciated from FIG. 3 that the metal gate 40 is formed on the substrate 5 such as the cathode electrode 10. Such a structure has an advantage that it minimizes the collision of gases/ions moving in a vertical direction so that the damage of the carbon nanotube 30 can be reduced. However, such a structure has a disadvantage that it is difficult to increase the number of carbon nanotubes per unit area as in FIGS. 1 and 2.

FIG. 4 is a cross-sectional view for explaining the concept of the triode type carbon nanotube field emitter of the prior art, wherein the metal gate is positioned below a cathode. It can be appreciated from FIG. 4 that the metal gate 40 is positioned below the cathode 10, interposing an insulation layer 50 therebetween. Such a structure does not have a problem that the number of the carbon nanotubes per unit area is not reduced as compared to the triode type carbon nanotube field emitter shown in FIG. 3. However, such a structure has a problem that it is difficult to increase the number of carbon nanotubes per unit area as in FIGS. 1 and 2.

Various structures as above have been proposed, however, since they have a disadvantage that the lifetime of the field emitter is shortened due to the problems such as separation of carbon nanotubes, evaporation due to high current density, etc., the carbon nanotube has not yet been commercialized. Therefore, a core technology in a technical field of the field emitter using the carbon nanotube may be said to be a technology of improving the lifetime of the carbon nanotube.

In the prior arts, a technology of making field emission from the carbon nanotube field emitter uniform (Taping Technique—J. M. Kim (SAIT) et al., Diamond and Related Materials, 2000, 9, 1184, Cyclic electrical aging-Y. C. Kim (LG FED Group) et al., Applied Physics Letters, 2004, 84, 5350), a technology of lowering field emission threshold voltage (Plasma Treatment—C. Y. Zhi (Chinese Academy of Sciences) et al., Applied Physics Letters, 2002, 81, 1690, Doping elements—J. C. Charlier et al., Nano Letters, 2002, 2, 1191.), etc., have been intensively studied. Also, a method for preventing the separation of the carbon nanotubes and improving the electrical conductivity of the carbon nanotube using a metal binder in order to improve the lifetime of the field emitter (S. H. Hong et al., Advanced Materials, 2006, 18, 553, J. M. Kim et al., Applied Physics Letters, 2005, 87, 063112.), a method for forming a metal layer in the phosphor in order to minimize the contamination of the carbon nanotube due to the vaporization/ionization of the phosphor (J. Li (Southeast Univ. China) et al., Applied Surface Science, 2003, 220, 96), etc., have been studied.

An improvement in lifetime of the carbon nanotube and an improvement in brightness of the field emitter are contrary to each other. In order to improve the brightness of the field emitter, current density should be increased or kinetic energy of electron should be increased. However, in order to improve the brightness of the field emitter, the method for increasing the kinetic energy of electron should apply high acceleration voltage and widen an interval between a cathode and an anode so that it has problems that energy efficiency is low and electrical stability is low since arcing is easily produced. In order to improve the brightness of the field emitter, the method for increasing the current density has a problem that the current density flowing per a single wire of the carbon nanotube should be increased so that the carbon nanotube is easily damaged due to heat generation caused by the increased current density. Furthermore, since the existing carbon nanotube field emitter has the two-dimensional structure (see FIGS. 1 to 4) so that the emitter area is restricted, the damage of the carbon nanotube is serious as the current density is increased. Also, in the carbon nanotube field emitter with the two-dimensional structure, since its structure is destroyed or its surface is contaminated due to the collision of gas and/or ionized particles from phosphor, so there is a disadvantage that the lifetime of the field emitter is shortened.

Consequently, since the existing carbon nanotube field emitter with the two-dimensional structure cannot easily increase the number of the carbon nanotubes per unit area so that the current density per the carbon nanotube is high, it cannot solve the problem that the carbon nanotube is damaged and since the existing carbon nanotube field emitter is spread in the two-dimensional structure, it cannot protect the carbon nanotube from the collision of gases/ions.

### SUMMARY OF THE INVENTION

Accordingly, it is a technical problem of the present invention to provide a carbon nanotube field emitter and a method for fabricating the same capable of maximizing its emitter area by designing the carbon nanotube field emitter in a three-dimensional structure to maximize the emitter area and improving its lifetime by protecting the carbon nanotube from the collision of gases/ions.

In order to solve the technical problems, a carbon nanotube field emitter of the present invention has a three-dimensional structure.

More specifically, a carbon nanotube field emitter of the present invention comprises: at least two paired electrode plates whose wide surfaces are faced with each other; carbon nanotubes formed on each of both surfaces of the electrode plates; a substrate vertically fixing the electrode plates in a state where the sides of the respective electrode plates contact each other; an anode electrode mounted in parallel with the substrate in a state spaced therefrom and having a phosphor facing the substrate; a direct current power supply applying direct voltage between the anode electrode and the electrode plates; and a pulse wave supplier periodically applying pulse waves indicating an opposite sign of voltage to any one of the paired electrode plates and the other thereof to allow them to alternately perform the role of the cathode electrode and the gate.

In the present invention, the ratio of length, which is the ratio of the height to the thickness of the electrode plate, is 1 or more.

Also, a glass substrate can be used as the substrate.

In order to solve the technical problem, a method for fabricating a carbon nanotube field emitter according to a first aspect of the present invention comprises the steps of: (a) fabricating a plurality of electrode plates whose at least one surface is formed with carbon nanotubes; (b) arranging the paired electrode plates whose wide surfaces are formed with the carbon nanotubes and are faced with each other; (c) mounting an anode electrode having a phosphor to be spaced from the electrode plates; (d) mounting a pulse wave supplier periodically applying pulse waves indicating an opposite sign of voltage between the paired electrode plates facing each other to allow them to alternately perform the role of the cathode electrode and the gate; and (e) mounting a direct current power supply applying direct voltage between the paired electrode plates facing each other and the anode electrode for acceleration of electrons emitted from the cathode plates toward the anode.

In this case, the step (a) comprises the steps of: (a-1) applying the mixture of the carbon nanotubes and carbon nanotube composite powders and organic binders to a plurality of predetermined regions on at least one surface of a base of the electrode plates; (a-2) forming the carbon nanotubes only on the applied region by calcinating the applied resultant products in vacuum; and (a-3) obtaining the plurality of electrode plates formed with the carbon nanotubes by cutting the base of the electrode plates to include the regions formed with the carbon nanotubes.

In order to solve the technical problems as mentioned above, a method for fabricating a carbon nanotube field emitter according to a second aspect of the present invention comprises the steps of: (a) allowing paired electrode plates whose at least one surface is formed with carbon nanotubes to be formed in plural in an arrangement state where the wide surfaces formed with the carbon nanotubes are faced with each other; (b) mounting an anode electrode having a phosphor to be spaced from the electrode plates; (c) mounting a pulse wave supplier periodically applying pulse waves indicating a different magnitude of voltage between the paired electrode plates facing each other to allow them to alternately perform the role of the cathode electrode and the gate; and (d) mounting a direct current power supply applying direct voltage between the paired electrode plates facing each other and the anode electrode for acceleration of electrons emitted from the cathode plates toward the anode.

In this case, the step (a) comprises the steps of: (a-1) film-forming a metal-based composite material layer including the carbon nanotube on a substrate; and (a-2) forming the plurality of paired electrode plates in an arrangement state where wide surfaces formed with the carbon nanotubes are faced with each other, by allowing the carbon nanotubes in a constant interval pattern to remain and removing only the metal-based composite material layer through etching.

Also, the step (a-2) of removing only the metal-based composite material layer through etching can be preformed using physical etching by laser irradiation or using chemical etching by chemical liquid.

On the other hand, in another case, the step (a) comprises the steps of: (a-1) forming a metal film on the substrate; (a-2) forming the plurality of paired electrode plates in an arrangement state where wide surfaces are faced with each other, by etching the metal film in a constant interval pattern; (a-3) applying a catalyst forming carbon nanotube to the side of the etched metal film; and (a-4) forming the carbon nanotube on the side of the etched metal film using the catalyst for growth of carbon nanotubes.

In this case, the step (a-4) of forming the carbon nanotube may be (1) a step of growing the carbon nanotube in a vacuum furnace by injecting gas having any one component selected from a group consisting of CH₄, C₂H₂, C₂H₄, C₂H₆, and CO, (2) a step of growing the carbon nanotube by placing the resultant products applied with the catalyst forming carbon nanotube into any one of a solvent group including carbon consisting of Co(CO)₈, Fe(CO)₅, Fe(C₅H₅)₂, Ethanol, Methanol, Xylene or mixed solvents thereof and then performing ultrasonic treatment thereon, and (3) a step of placing the resultant products into carbon nanotube solution formed of the carbon nanotube or the composite material including the carbon nanotube and a solvent whose boiling point is 300° C. or less or spraying the solution on the resultant products.

### BRIEF DESCRIPTION OF THE DRAWINGS

These and other objects, features, and advantages of preferred embodiments of the present invention will be more fully described in the following detailed description, taken in conjunction with the accompanying drawings. In the drawings:

FIG. 1 is a cross-sectional view for explaining the concept of a diode type carbon nanotube field emitter of the prior art;

FIG. 2 is a cross-sectional view for explaining the concept of a triode type carbon nanotube field emitter of the prior art using a metal grid gate;

FIG. 3 is a cross-sectional view for explaining the concept of the triode type carbon nanotube field emitter of the prior art, wherein the metal gate is positioned at a side of a substrate;

FIG. 4 is a cross-sectional view for explaining the concept of the triode type carbon nanotube field emitter of the prior art, wherein the metal gate is positioned below a cathode;

FIG. 5 is a view showing a schematic construction of a carbon nanotube field emitter according to the present invention;

FIGS. 6A to 6E are process views for explaining a first embodiment of a method for forming a carbon nanotube array structure in a three-dimensional structure applied to the carbon nanotube field emitter shown in FIG. 5;

FIGS. 7A to 7C are process views for explaining a second embodiment of a method for forming a carbon nanotube array structure in a three-dimensional structure applied to the carbon nanotube field emitter shown in FIG. 5; and

FIGS. 8A to 8E are process views for explaining a third embodiment of a method for forming a carbon nanotube array structure in a three-dimensional structure applied to the carbon nanotube field emitter shown in FIG. 5.

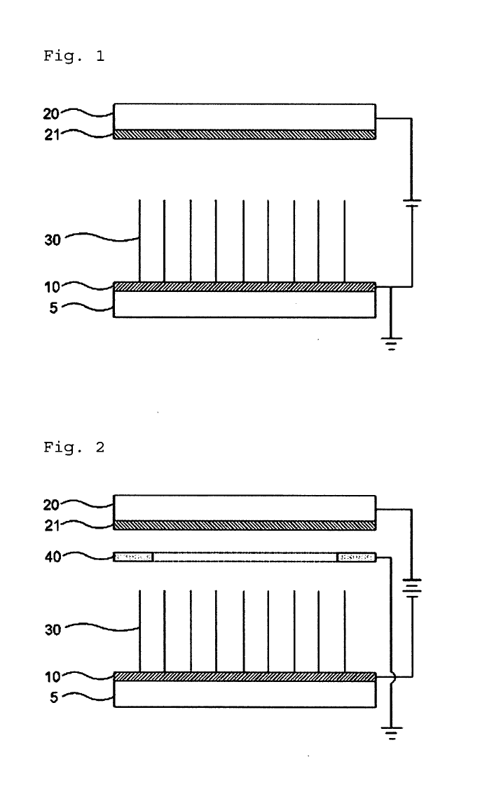

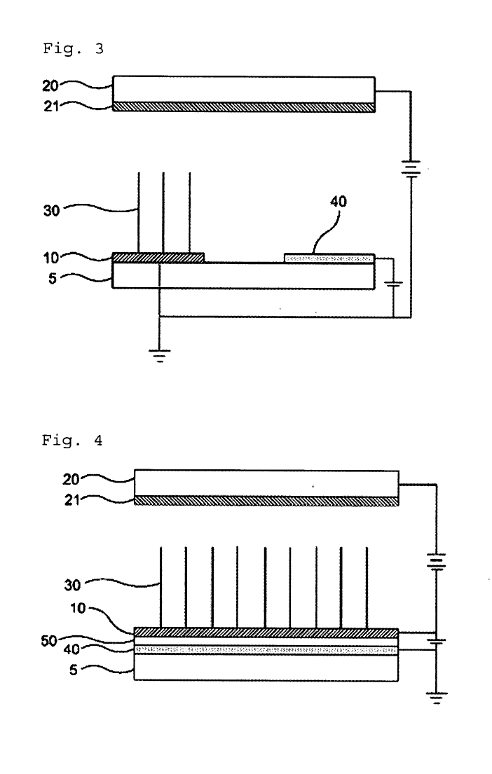

### DETAILED DESCRIPTION OF THE INVENTION

Hereinafter, the preferred embodiments of the present invention will be described with reference to the accompanying drawings. The present embodiments do not limit the scope of the present invention but are proposed only by way of example. The same parts in different embodiments are indicated by the same signs and terms.

FIG. 5 is a view showing a schematic construction of a carbon nanotube field emitter according to an embodiment of the present invention. Referring to FIG. 5, an anode electrode 20 formed with a phosphor 21 faces an insulating substrate 15. Also, both sides of cathode electrodes 10 with a three-dimensional structure are formed with carbon nanotubes 30, wherein the plurality of cathode electrodes 10 are vertically arranged in a state where one side of each cathode electrode 10 contacts the insulating substrate 15. Herein, the reason for referring to be the three-dimensional structure is that in the prior art, the carbon nanotube is two-dimensionally formed on the cathode electrode and is used for the carbon nanotube field emitter as it is, however, in the present invention, the carbon nanotube three-dimensionally formed considering a height due to the vertical arrangement of the plurality of cathode electrodes 10, is used for the carbon nanotube field emitter. The plurality of cathode electrodes 10 are arranged in a row so that their wide surfaces formed with the carbon nanotubes 30 face each other or their narrow surfaces are parallel with each other. Direct current voltage is supplied between the cathode electrode 10 and the anode electrode 20. The cathode electrodes 10 whose wide surfaces formed with the carbon nanotubes 30 face each other are supplied with pulse waves by means of a pulse wave supplier 60. When the pulse waves are supplied, gates 40 and the cathode electrodes 10, which make pairs and face each other, alternately perform their roles. Preferably, the ratio of length of the cathode electrode 10 (the height 80 of the cathode/the thickness 70 of the cathode) is 1 or more. Theoretically, the ratio of length of the cathode electrode can be large without any restriction. However, the height 80 of the cathode electrode is subject to the limitation by means of an interval between the anode electrode 20 formed with the phosphor 21 and the insulating substrate 15. The reason for making the ratio of length 1 or more is that the large number of cathode electrodes 10 and gates 40 can be formed on the insulating substrate 15 with a predetermined area so that the carbon nanotube field emitter with excellent performance can be fabricated. The carbon nanotube field emitter according to the embodiment of the present invention having such a structure has advantages as follows:

(1) Since the carbon nanotube field emitter of the present invention has the three-dimensional structure, as the ratio of length of the cathode electrode is getting higher, the formation area (hereinafter, referred to as “emitter area”) of the carbon nanotube serving as the field emitter becomes wider so that the efficiency of the carbon nanotube field emitter can be high.

(2) Although the present invention and the prior art is the same in efficiency, since the present invention has a wider emitter area than that of the prior art, the carbon nanotube field emitter of the present invention can lower the current density flowing per single wire of the carbon nanotube to ½ or less as compared to the carbon nanotube field emitter of the prior art with the two-dimensional structure. Therefore, the present invention minimizes the damage of the carbon nanotube so that the lifetime of the carbon nanotube field emitter can be improved.

(3) Since the carbon nanotube 30 of the present invention is formed to be substantially horizontal to the surface of the anode electrode 20 or the phosphor 21, the collision of gases/ions moving in a vertical direction is minimized so that the damage of the carbon nanotube 30 can be prevented, making it possible to improve the lifetime of the carbon nanotube field emitter.

The following embodiments are to explain a method for fabricating the carbon nanotube field emitter of the embodiments of the present invention shown in FIG. 5. Since the most important thing in the method of the present invention is a method for forming the carbon nanotube array structure with the three-dimensional structure in the entire structure of the carbon nanotube field emitter, the description will be made up to this fabricating step through the drawings and the description of the method for forming the remaining components will be described with reference to FIG. 5.

### EMBODIMENT 1

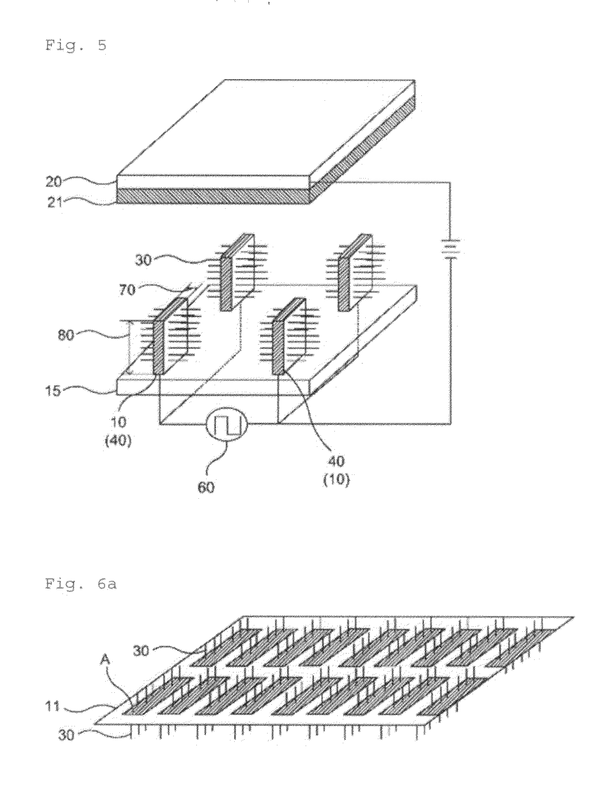

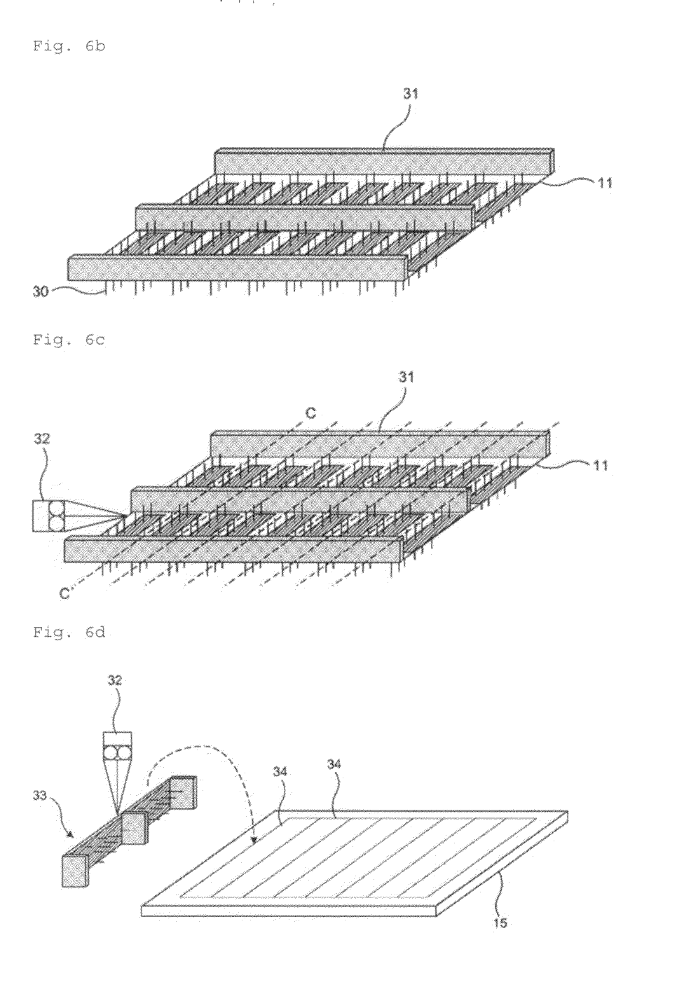

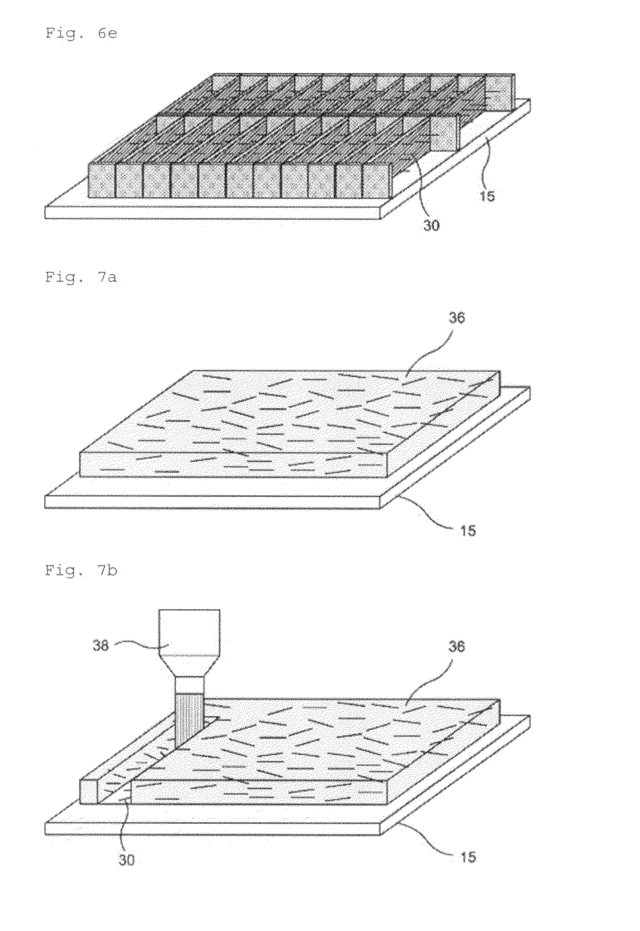

The carbon nanotubes and carbon nanotube composite powders are mixed with organic binders formed of ethylcellulose and terpineol using a 3-roll mill and a duplication screen printing is then performed on a base 11 for conductive cathode electrodes (or gates) using the mixture. Thereafter, application should be performed only on defined regions by means of masks regularly exposing regions A where the cathode electrodes (or gates) will be made. In the present embodiment, the regions A where the cathode electrodes (or gates) will be made have a rectangular shape and are two-dimensionally arranged at a constant interval. Then, they are calcinated at 100 to 500° C. in a vacuum of 1 mTorr or less so that the carbon nanotubes 30 with the two-dimensional structure as shown in FIG. 6A are formed.

Next, glass spacers 31 are mounted along short sides of the circumferences of the regions formed with the carbon nanotubes 30 with the two-dimensional structure to complete the structure shown in FIG. 6B. The glass spacers 31 are mounted by the screen printing of glass frit or the application of insulating adhesives to glass plates cut at a constant thickness or glass beads with a constant diameter. In the case of the screen printing of the glass frit, on the contrary to the screen printing performed in FIG. 6A, masks not to apply glass to the regions A where the cathode electrodes (or gates) will be made are used.

Subsequently, as the resultant products of FIG. 6B, the base 11 for the conductive cathode electrodes (or gates) and the glass spacers 31 are cut at a constant width by means of a laser cutter or a diamond cutter (not shown) along a cutting line C-C′, as shown in FIG. 6C. The width is not particularly limited, but can be finely cut to be 10 μm to several millimeters. The cathode electrodes (or gates) formed with the cut carbon nanotubes with the two-dimensional structure can be lifted up by means of a pincette or a robot arm 32 and can then be moved.

Furthermore, as shown in FIG. 6D, assembly grooves 34 are prepared at a constant interval on the insulating substrate 15, for example, the glass substrate so that cutting bodies 33 of the cathode electrodes (or gates) formed with the carbon nanotubes can be arranged and the cutting bodies 33 of the cathode electrodes (or gates) formed with the carbon nanotubes are mounted to be fitted in the assembly grooves 34 by means of the pincette or the robot arm 33 so that the carbon nanotube array structure with the three-dimensional structure is completed as shown in FIG. 6E.

From after the carbon nanotube array structure with the three-dimensional structure is completed, the process of completing the entire structure of the carbon nanotube field emitter will be described with reference to FIG. 5. As shown in FIG. 5, the anode electrode 20 formed with the phosphor 21 is mounted to be faced with the insulating substrate 15 and the direct current voltage is supplied between the cathode electrodes or the gates 10 or 40 and the anode electrode 20. Also, the gates 40 and the cathode electrodes 10 whose wide surfaces facing each other formed with the carbon nanotubes 30 are supplied with the pulse wave by means of the pulse wave supplier 60 so that the gates 40 and the cathode electrodes 10 whose wide surfaces face each other alternately perform their roles so that the carbon nanotube field emitter is completed.

### EMBODIMENT 2

A metal-matrix composite material layer 36 including the carbon nanotubes with a thickness of 10 μm to several millimeters is film-formed on the insulating substrate 15, for example, the glass substrate so that a structure as shown in FIG. 7A is formed.

Next, as shown in FIG. 7B, the composite material layer 36 including the carbon nanotubes is irradiated with a CO₂ laser 38 beam having an output power of 1 to 5 W at a scanning speed of 0.1 to 100 mm per second so that the metal is selectively etched and the cathode electrodes 10 (or gates 40) and the carbon nanotubes 30 remain.

By repeating such an etching, the metal-matrix composite material layer 36 is formed with stripe patterns having a width of 0.1 to 500 μm at an interval of 0.1 to 500 μm so that the carbon nanotube array structure with the three-dimensional structure is completed as shown in FIG. 7C.

From after the carbon nanotube array structure with the three-dimensional structure is completed, the process of completing the entire structure of the carbon nanotube field emitter is the same as the embodiment 1 and the further description thereof will thus be omitted.

In the present embodiment 2, in order to etch the composite material layer 36 including the carbon nanotubes, physical etching using laser is used. In addition to the physical etching, chemical etching using a mask pattern and chemical liquid may be applied.

### EMBODIMENT 3

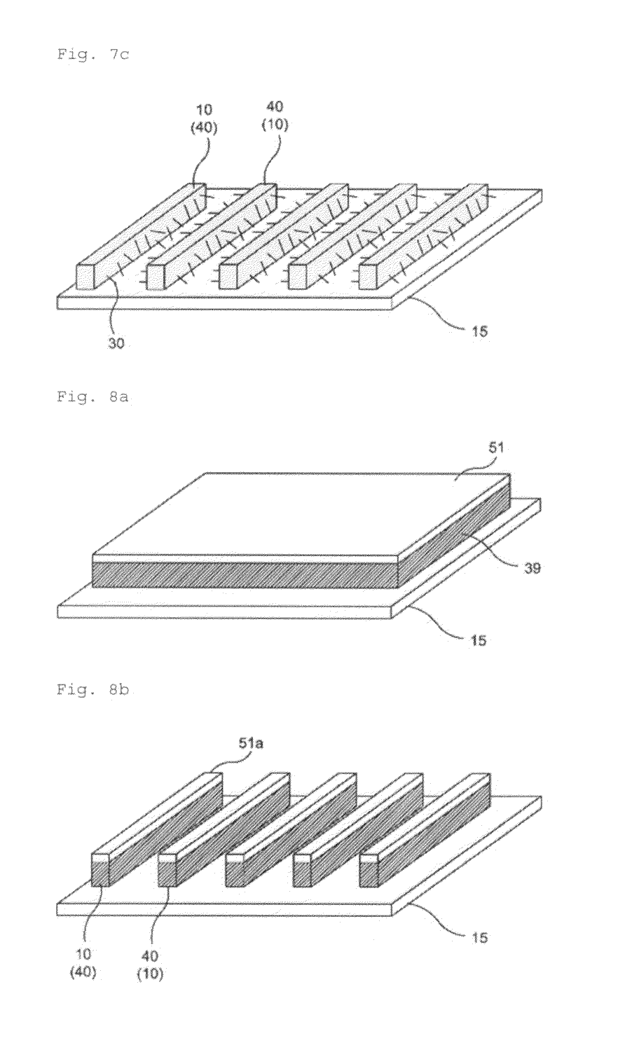

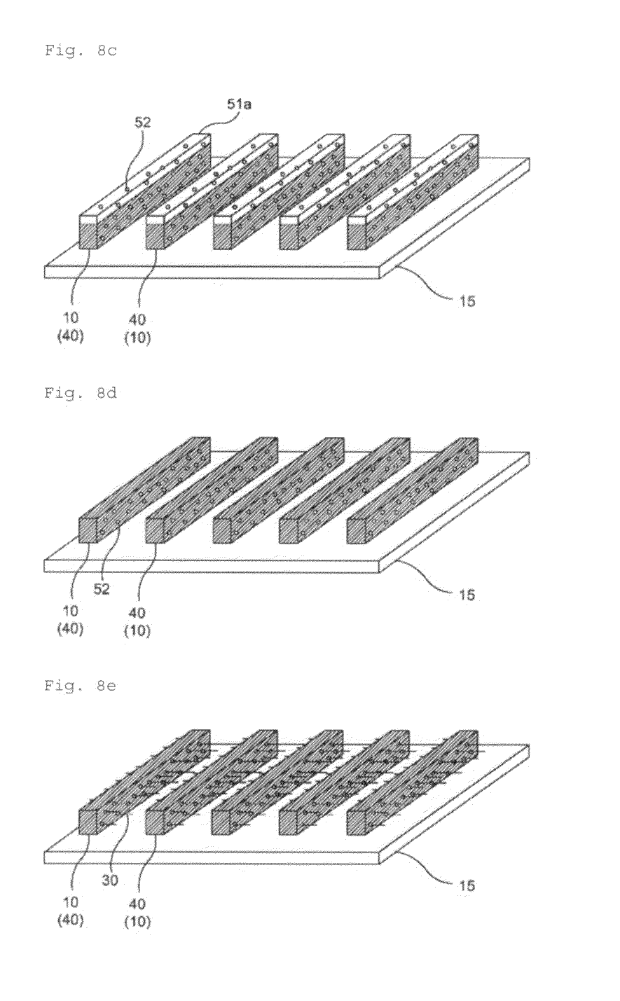

As shown in FIG. 8A, a metal layer 39 of a thickness of 10 μm to several millimeters is first formed on the insulating substrate 15, for example, the glass substrate and a photoresist 51 is then applied thereon.

Next, as shown in FIG. 8B, UV is exposed through the mask with the stripe patterns having a width of 5 to 500 μm and the photoresist is then removed to obtain a photoresist pattern 51a. Thereafter, the metal layer 39 is etched to obtain the metal cathode electrode 10 or the gate 40.

Next, a carbon nanotube growth catalyst 52 is applied to obtain a structure shown in FIG. 8C. The carbon nanotube growth catalyst 52 includes at least one of Fe, Co, and Ni.

Next, as shown in FIG. 8D, the photoresist pattern 51a is removed so that the carbon nanotube growth catalyst 52 remains only on the side of the metal cathode electrode 10 or the gate 40.

Next, the carbon nanotube array structure with the three-dimensional structure as shown in FIG. 8E is completed by putting the resultant products of FIG. 8D into a vacuum furnace at 100 to 900° C. and growing the carbon nanotube 30 while gas having any one component selected from a group consisting of CH₄, C₂H₂, C₂H₄, C₂H₆, and CO flows.

From after the carbon nanotube array structure with the three-dimensional structure is completed, the process of completing the entire structure of the carbon nanotube field emitter is the same as the embodiment 1 and the further description thereof will thus be omitted.

In the present embodiment 3, the method for performing vacuum heat treatment under gas atmosphere for the carbon nanotube growth in order to form the carbon nanotube is described. In addition to the method, there are methods for forming the carbon nanotube as follows:

(a) The carbon nanotube can be formed by putting the resultant products of FIG. 8D into a solvent including carbon such as Co(CO)₈, Fe(CO)₅, Fe(C₅H₅)₂, Ethanol, Methanol, Xylene or mixed solvents thereof and then performing ultrasonic treatment thereon.

(b) The carbon nanotube can be formed by putting the resultant products of FIG. 8D into carbon nanotube solution formed of the carbon nanotube or the composite material including the carbon nanotube and a solvent whose boiling point is 300° C. or less or by spraying the solution on the resultant products.

With the present invention as above, the damage of the carbon nanotube is minimized so that the lifetime of the carbon nanotube field emitter can be remarkably improved as well as the carbon nanotube field emitter with excellent performance can be fabricated. Also, the carbon nanotube field emitter with such a structure can be widely applied to the most advanced fields such as a field emission display, a backlight unit, an X-ray source, a field emission scanning microscope/a field emission tunneling microscope, a sensor, etc.

What is claimed is:

1. A carbon nanotube field emitter having a three-dimensional structure.

2. A carbon nanotube field emitter comprising:
at least two paired electrode plates whose wide surfaces are faced with each other;
carbon nanotubes formed on each of both surfaces of the electrode plates;
a substrate vertically fixing the electrode plates in a state where the sides of the respective electrode plates contact each other;
an anode electrode mounted in parallel with the substrate at a state spaced therefrom and having a phosphor facing the substrate;
a direct current power supply applying direct voltage between the anode electrode and the electrode plates; and
a pulse wave supplier periodically applying pulse waves indicating a different magnitude of voltage to any one of the paired electrode plates and the other thereof to allow them to alternately perform the role of the cathode electrode and the gate.

3. The carbon nanotube field emitter of claim 2, wherein the ratio of length, which is the ratio of the height to the thickness of the electrode plate, is 1 or more.

4. The carbon nanotube field emitter of claim 2, wherein the substrate is a glass substrate.

5. A method for fabricating a carbon nanotube field emitter comprising the steps of:
(a) fabricating a plurality of electrode plates whose at least one surface is formed with carbon nanotubes;
(b) arranging the paired electrode plates whose wide surfaces are formed with the carbon nanotubes and are faced with each other;
(c) mounting an anode electrode having a phosphor to be spaced from the electrode plates;
(d) mounting a pulse wave supplier periodically applying pulse waves indicating a different magnitude of voltage between the paired electrode plates facing each other to allow them to alternately perform the role of the cathode electrode and the gate; and
(e) mounting a direct current power supply applying direct voltage between the paired electrode plates facing each other and the anode electrode.

6. The method of claim 5, wherein the step (a) comprises the steps of:
(a-1) applying the mixture of the carbon nanotubes and carbon nanotube composite powders and organic binders only to a plurality of predetermined regions on at least one surface of a base of the electrode plates;
(a-2) forming the carbon nanotubes only on the applied region by calcinating the applied resultant products in vacuum; and
(a-3) obtaining the plurality of electrode plates formed with the carbon nanotubes by cutting the base of the electrode plates to include the regions formed with the carbon nanotubes.

7. A method for fabricating a carbon nanotube field emitter comprising the steps of:
(a) allowing paired electrode plates whose at least one surface is formed with carbon nanotubes to be formed in plural in an arrangement state where the wide surfaces formed with the carbon nanotubes are faced with each other;
(b) mounting an anode electrode having a phosphor to be spaced from the electrode plates;
(c) mounting a pulse wave supplier periodically applying pulse waves indicating a different magnitude of voltage between the paired electrode plates facing each other to allow them to alternately perform the role of the cathode electrode and the gate; and
(d) mounting a direct current power supply applying direct voltage between the paired electrode plates facing each other and the anode electrode.

8. The method of claim 7, wherein the step (a) comprises the steps of:
(a-1) film-forming a metal based composite material layer including the carbon nanotube on a substrate; and
(a-2) forming the plurality of paired electrode plates in an arrangement state where wide surfaces formed with the carbon nanotubes are faced with each other, by allowing the carbon nanotubes in a constant interval pattern to remain and removing only the metal-based composite material through etching.

9. The method of claim 8, wherein the step (a-2) of removing only the metal-based composite material through etching is preformed by using physical etching by laser irradiation.

10. The method of claim 8, wherein the step (a-2) of removing only the metal-based composite material through etching is preformed by using chemical etching by chemical liquid.

11. The method of claim 7, wherein the step (a) comprises the steps of:
(a-1) forming a metal film on the substrate
(a-2) forming the plurality of paired electrode plates in an arrangement state where wide surfaces are faced with each other, by etching the metal film in a constant interval pattern;
(a-3) applying a catalyst forming carbon nanotube to the side of the etched metal film; and
(a-4) forming the carbon nanotube on the side of the etched metal film using the catalyst forming carbon nanotube as a medium.

12. The method of claim 11, wherein the step (a-4) of forming the carbon nanotube is a step of growing the carbon nanotube in a vacuum furnace by injecting gas having any one component selected from a group consisting of CH₄, C₂H₂, C₂H₄, C₂H₆, and CO.

13. The method of claim 11, wherein the step (a-4) of forming the carbon nanotube is a step of growing the carbon nanotube by putting the resultant products applied with the catalyst forming carbon nanotube into any one of a solvent group including carbon consisting of Co(CO)₈, Fe(CO)₅, Fe(C₅H₅)₂, Ethanol, Methanol, Xylene or mixed solvents thereof and then performing ultrasonic treatment thereon.

14. The method of claim 11, wherein the step (a-4) of forming the carbon nanotube is a step of putting the resultant products into carbon nanotube solution formed of the carbon nanotube or the composite material including the carbon nanotube and a solvent whose boiling point is 300° C. or less or spraying the solution on the resultant products.
